(19) United States
(12) Patent Application Publication
(10) Pub. No.: US 2023/0083252 A1
(43) Pub. Date: Mar. 16, 2023

(54) SYSTEMS AND METHODS FOR ONBOARDING AND SUPPORTING CREDIT PRODUCT PARTNERS

(71) Applicant: Mercury Financial Holdings LLC, Wilmington, DE (US)

(72) Inventors: Sateeshasatya Anvesh Reddy KATAMREDDY, Wilmington, DE (US); Van Hieu TRAN, Wilmington, DE (US); Jie ZHENG, Wilmington, DE (US); Anal R. SHAH, Wilmington, DE (US); Cory KELLY, Wilmington, DE (US)

(73) Assignee: Mercury Financial Holdings LLC, Wilmington, DE (US)

(21) Appl. No.: 17/941,369

(22) Filed: Sep. 9, 2022

Related U.S. Application Data
(60) Provisional application No. 63/243,451, filed on Sep. 13, 2021.

(51) Int. Cl. G06Q 40/02

(52) U.S. Cl. CPC G06Q 40/025

(57) ABSTRACT

Disclosed herein is a scalable onboarding system and methods for efficiently onboarding one or more new partner channels into credit product company's system. The onboarding system and methods may create, use, and test different types of logic: core logic and partner-specific logic. The core logic may be logic that performs common functions among the partner channels, and the partner-specific logic may be logic that performs partner-specific functions. The partner-specific logic may originate from modular and customizable logic, modified to include partner-specific branding elements, functions, and configurations. Each time a new partner channel is onboarded into the credit product company's system, in some embodiments, only the partner-specific logic may need to be created and tested. This allows new partner channels to be quickly added without requiring new logic be written for each new partner channel. The faster onboarding process may increase the number of credit product applicants and the acquisition rate.

### CROSS-REFERENCE TO RELATED APPLICATION

This application claims the benefit of U.S. provisional application No. 63/243,451, filed Sep. 13, 2021, the contents of which are incorporated herein by reference in its entirety for all purposes.

### FIELD OF DISCLOSURE

This disclosure relates to systems and methods for onboarding and supporting new partner channels, such as channels for affiliate partner(s), co-branded partner(s), etc. into a credit product company's system.

### BACKGROUND

Credit product companies are typically affiliated with partners. A partner may invite customers to apply for a credit product (e.g., credit card, line of credit, etc.) with an affiliated credit product company. This invitation may involve providing the customer with a link that, when clicked by the customer, may direct the customer to a website where the customer may apply for a credit product and submit a corresponding credit product application. This website may be hosted by the partner's system. The partner may be a co-branded partner, for example, where the credit product issued to the customer would be a co-branded credit product.

When a credit product company affiliates with a new partner, a new partner channel is created and involves onboarding the new partner channel into the credit product company's system. This onboarding process typically involves creating separate logic for each partner channel for the entire credit product application process. Certain steps in the separate logic may slow down the time needed to onboard a new partner channel and act as a bottleneck. Exemplary bottleneck steps include designing and implementing a new credit product application page (website), developing a partner setup backend application programmable interface (API), developing and testing logic for each partner channel, and adding and testing configurations. This separate logic for each partner channel may lead to inefficiencies due to the amount of development overhead.

What is needed is an onboarding system for onboarding a new partner channel into a technology platform and corresponding methods that are fast and efficient with a reduced amount of development overhead. The onboarding system and corresponding method should efficiently integrate new partner channels while also being able to incorporate partner-specific branding, logic, and configurations.

### BRIEF SUMMARY

A computer-implemented method for processing a credit product application is disclosed. The method comprises: directing a customer to an application page hosted by a credit product company system; retrieving one or more partner-specific branding elements from a content management system; performing one or more partner-specific functions using partner-specific logic, the one or more partner-specific functions comprising at least one of: invoking, using a process flow engine interface, a process flow engine to perform underwriting, partner application pre-processing, or partner application post-processing, displaying a user interface, wherein the user interface comprises the one or more partner-specific branding elements, receiving customer input, creating the credit product application using the customer input, or submitting the credit product application; and displaying a status of the credit product application, wherein the content management system and the process flow engine interface are included in core logic of the credit product company system. Additionally or alternatively, in some embodiments, the core logic comprises one or more of: a content distribution network, a web client, web servers, a backend application, an internal facing front end application, an external facing front end application, a data layer, or a cache layer. Additionally or alternatively, in some embodiments, the performing the one or more partner-specific functions comprises requesting a backend application to retrieve customer data. Additionally or alternatively, in some embodiments, the method further comprises: pre-populating the credit product application with the customer data. Additionally or alternatively, in some embodiments, the method further comprises: decrypting the customer data from an encrypted payload. Additionally or alternatively, in some embodiments, the method further comprises: retrieving one or more partner-specific configurations from a data layer of the credit product company system, wherein the user interface further comprises one or more partner-specific offer information, the one or more partner-specific offer information included in the one or more partner-specific configurations. Additionally or alternatively, in some embodiments, the one or more partner-specific functions are defined by a partner when onboarding a corresponding new partner channel into the credit product company system.

A computer-implemented method for onboarding a new partner channel into a credit product company system is disclosed. The method comprises: presenting a user interface of an onboarding configuration page; receiving partner information of the new partner channel, wherein the partner information comprises one or more partner-specific branding elements, one or more partner-specific functions, or one or more partner-specific configurations; sending the partner information to a services layer; adding the new partner channel to an admin user interface; creating a partner-specific application page; and developing partner-specific logic for implementing the one or more partner-specific functions, wherein the partner-specific logic is programmed to operate with core logic, wherein the core logic is developed before the onboarding the new partner channel and is used by multiple partner channels. Additionally or alternatively, in some embodiments, the creating the partner-specific application page comprises creating a partner-specific user interface for a partner-specific application page. Additionally or alternatively, in some embodiments, the creating the partner-specific user interface for the partner-specific application page comprises modifying a user interface by including the one or more partner-specific branding elements. Additionally or alternatively, in some embodiments, the developing the partner-specific logic comprises modifying logic to include the one or more partner-specific branding elements, the one or more partner-specific functions, or the one or more partner-specific configurations. Additionally or alternatively, in some embodiments, the method further comprises: generating reporting configurations for the new partner channel using the one or more partner-specific configurations. Additionally or alternatively, in some embodiments, the reporting configurations specify one or more of: which tables and columns to include in reports, frequency of reporting, or recipients. Additionally or alternatively, in some embodiments, after the developing the partner-specific logic, testing only the partner-specific logic. Additionally or alternatively, in some embodiments, the onboarding configuration page allows a partner to drag and drop steps to create partner-specific flows for implementing the one or more partner-specific functions.

A credit product company system architecture is disclosed. The credit product company system architecture comprises: a presentation layer programmed to present a user interface to a user; a services layer comprising partner data used in application processing steps or reporting steps; a business layer comprising a process flow engine interface, a content management system, and partner configuration data, wherein the process flow engine interfaces with a process flow engine; and a data layer comprising database information, the database information comprising entities, repositories, and data transfer objects. Additionally or alternatively, in some embodiments, the services layer communicates reporting results to one or more external systems. Additionally or alternatively, in some embodiments, when onboarding a new partner channel into the credit product company system, only the business layer is changed. Additionally or alternatively, in some embodiments, the changing only the business layer comprises: adding one or more partner-specific branding elements to the content management system, adding the partner configuration data, or adding one or more partner-specific logic and flows. Additionally or alternatively, in some embodiments, wherein the user is a new partner, the architecture further comprising: a backend application that sends partner information received by the user interface to the services layer, authenticates the new partner, checks the partner information, and executes partner-specific flows.

### BRIEF DESCRIPTION

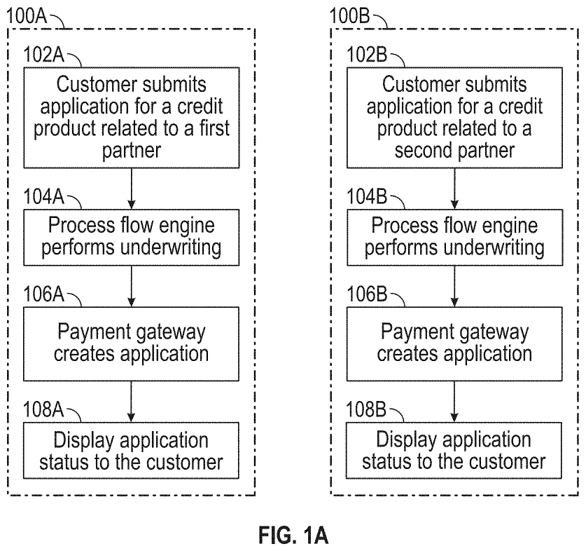

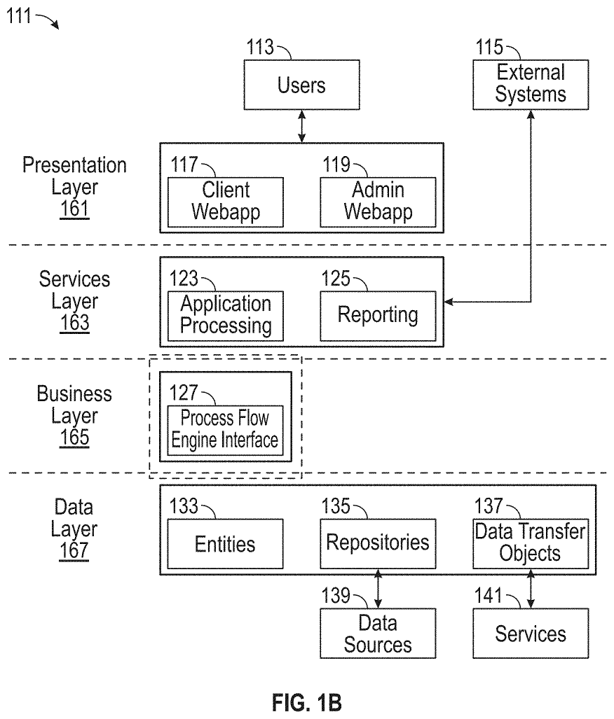

FIG. 1A illustrates partner channels for a prior art onboarding system where customers apply for credit products with a partner.

FIG. 1B illustrates a high-level block diagram of an architecture of a prior art partner channel.

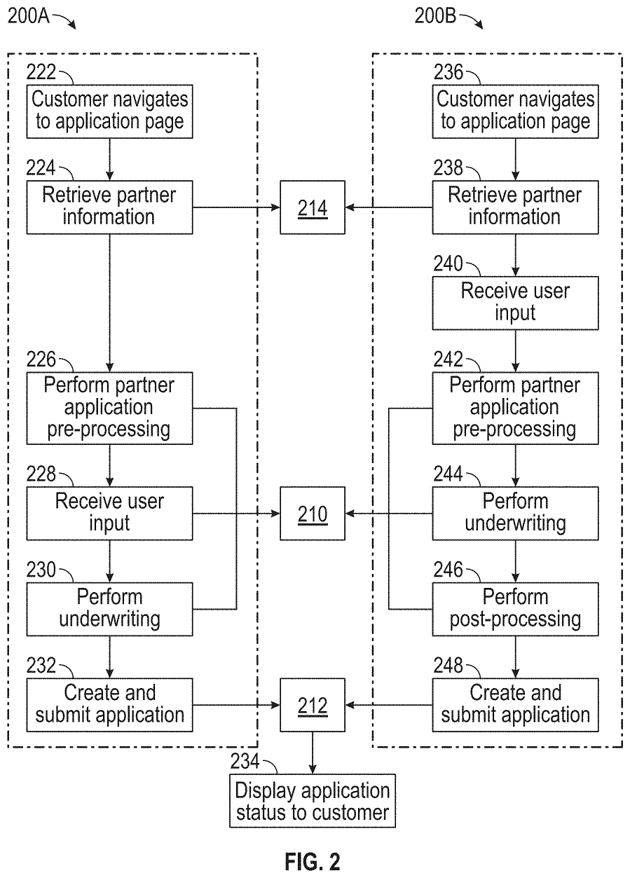

FIG. 2 illustrates an exemplary onboarding system and flows where customers apply for credit products with different partners (e.g., an affiliate partner or co-branded partner), according to embodiments of the disclosure.

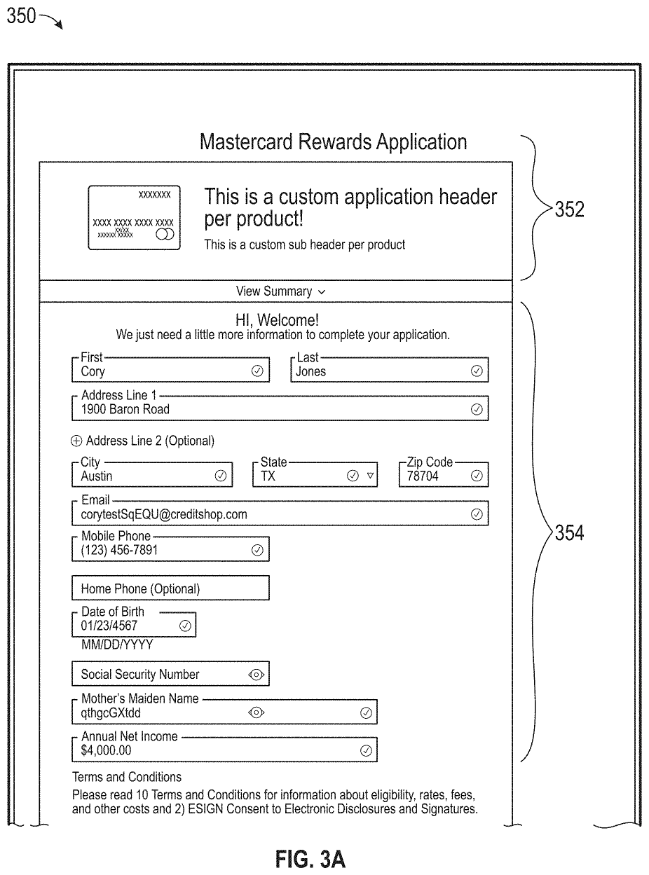

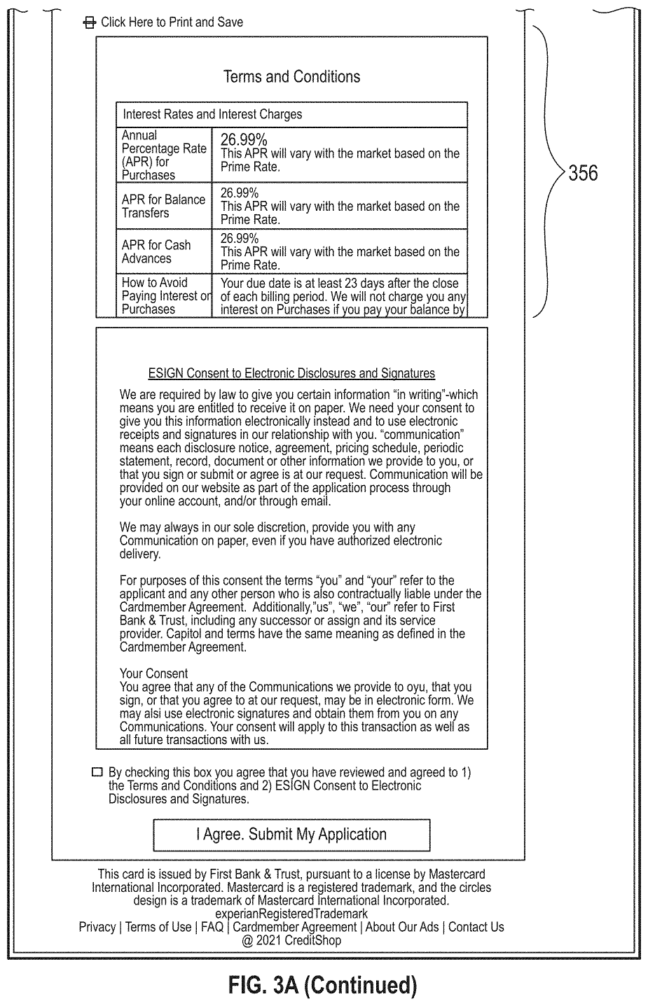

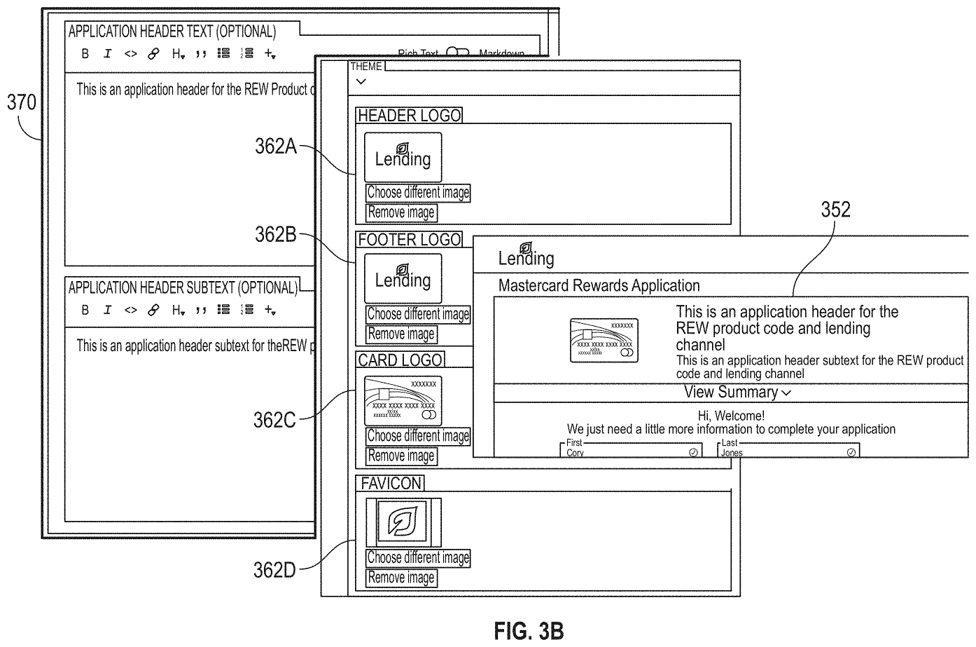

FIG. 3A illustrate an exemplary user interface for a partner-specific application page, according to embodiments of the disclosure.

FIG. 3B illustrates exemplary partner-specific branding elements, according to embodiments of the disclosure.

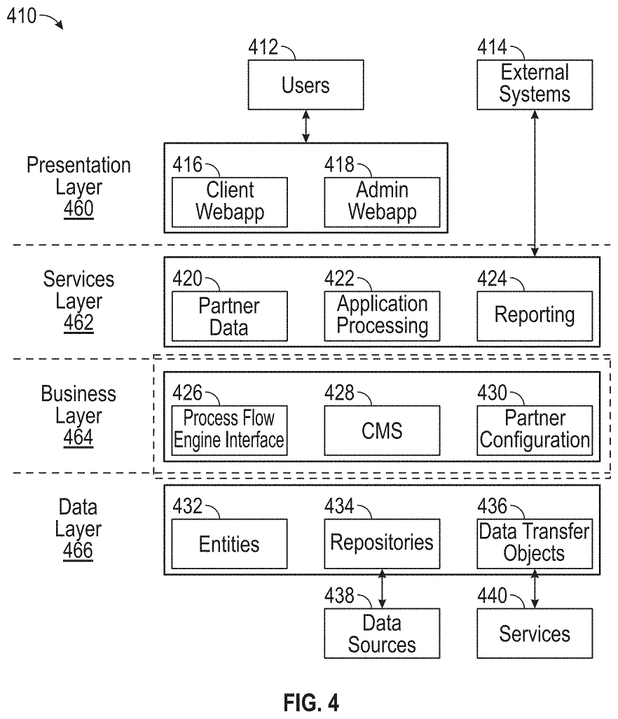

FIG. 4 illustrates a high-level block diagram of an exemplary architecture of a partner channel, according to embodiments of the disclosure.

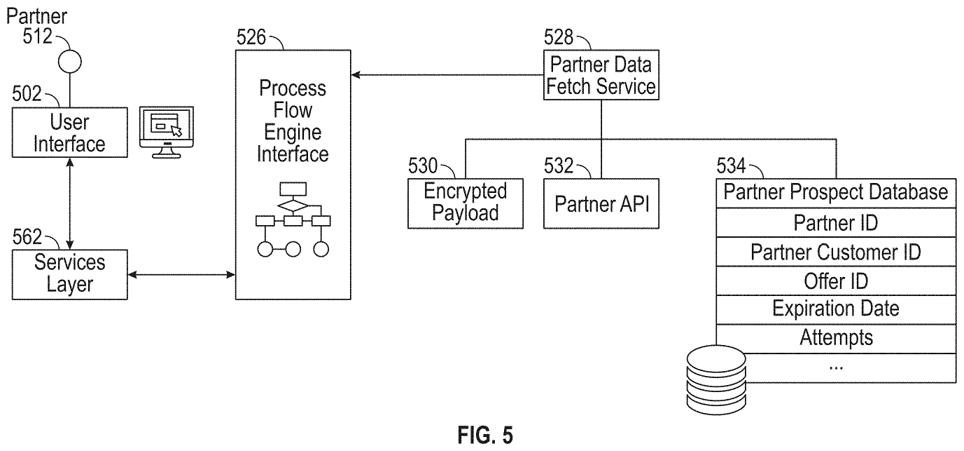

FIG. 5 illustrates a high-level block diagram of an exemplary process for onboarding a new partner channel, according to embodiments of the disclosure.

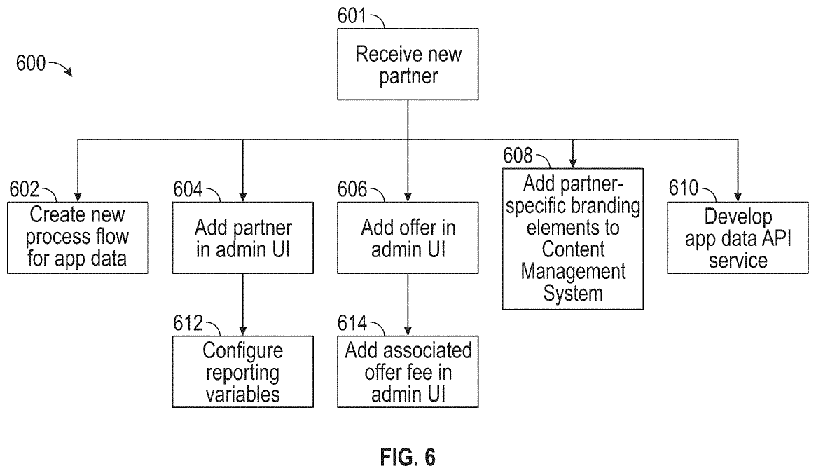

FIG. 6 illustrates a flow chart of an exemplary process for onboarding a new partner channel, according to embodiments of the disclosure.

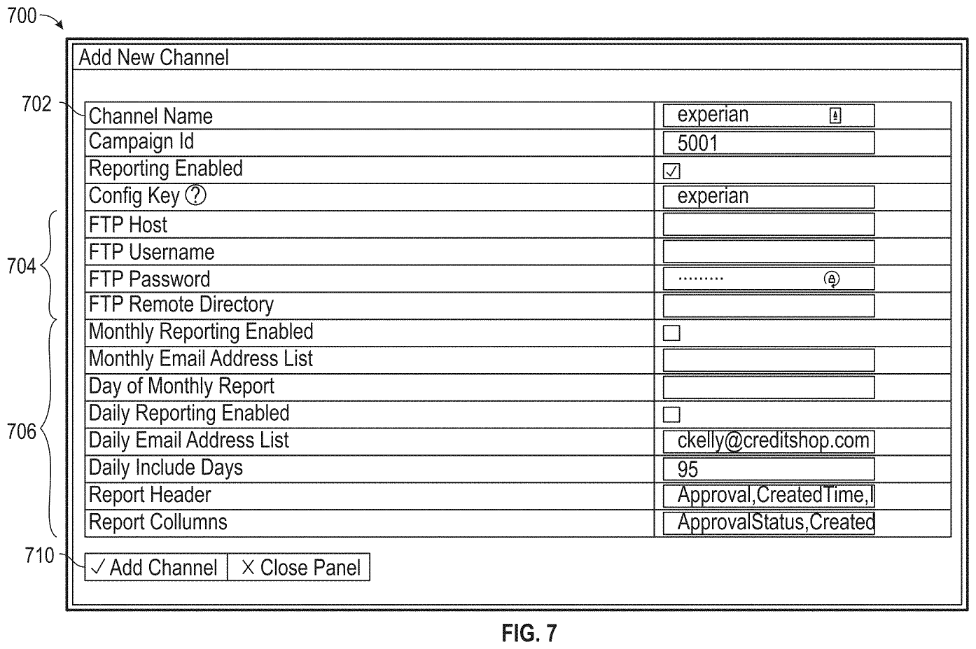

FIG. 7 illustrates an exemplary onboard configuration page for onboarding a new partner channel, according to embodiments of the disclosure.

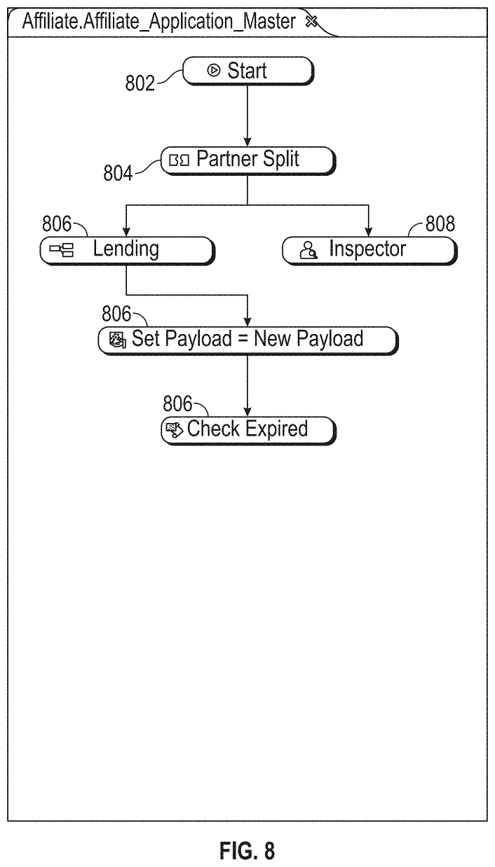

FIG. 8 illustrates an exemplary flow implemented by a flow engine, according to embodiments of the disclosure.

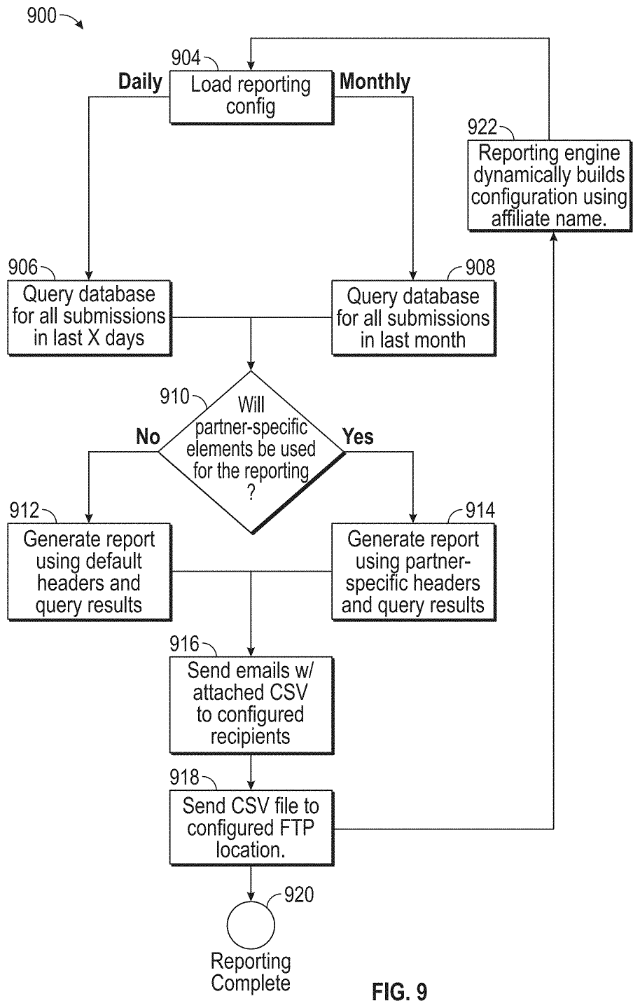

FIG. 9 illustrates an exemplary reporting flow of a new partner channel onboarded on the technology platform, according to embodiments of the disclosure.

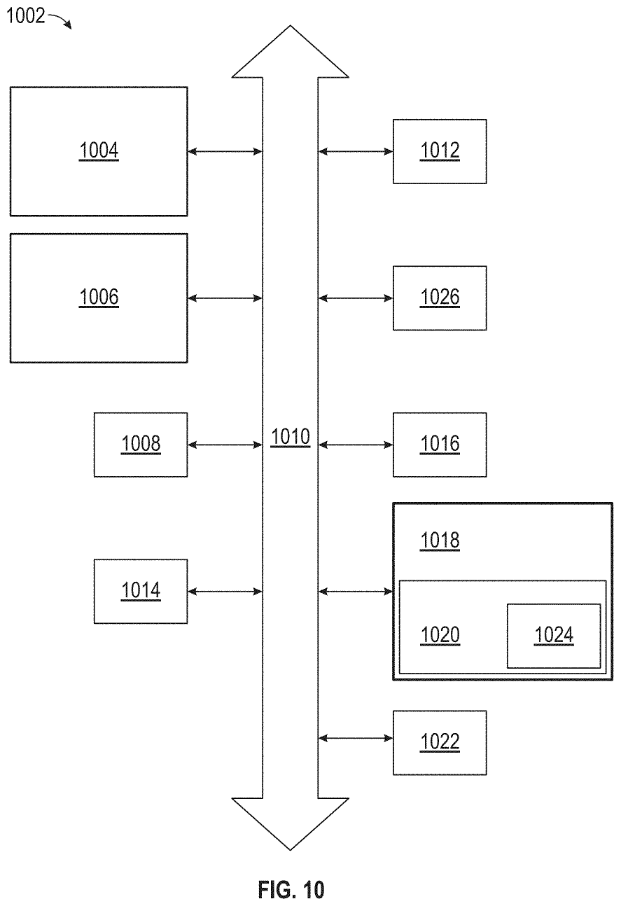

FIG. 10 illustrates a block diagram of an exemplary system, according to embodiments of the disclosure.

### DETAILED DESCRIPTION

Disclosed herein is a scalable onboarding system and methods for efficiently onboarding one or more new partner channels into credit product company's system. The onboarding system and methods may create, use, and test different types of logic: core logic and partner-specific logic. The core logic may be logic that performs common functions among the partner channels, and the partner-specific logic may be logic that performs partner-specific functions. The partner-specific logic may originate from modular and customizable logic, modified to include partner-specific branding elements, functions, and configurations. Each time a new partner channel is onboarded into the credit product company's system, in some embodiments, only the partner-specific logic may need to be created and tested. This allows new partner channels to be quickly added without requiring new logic be written for each new partner channel. The faster onboarding process may increase the number of credit product applicants and the acquisition rate.

The following description is presented to enable a person of ordinary skill in the art to make and use various embodiments. Descriptions of specific devices, techniques, and applications are provided only as examples. These examples are being provided solely to add context and aid in the understanding of the described examples. It will thus be apparent to a person of ordinary skill in the art that the described examples may be practiced without some or all of the specific details. Other applications are possible, such that the following examples should not be taken as limiting. Various modifications in the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various techniques and process flow steps will be described in detail with reference to examples as illustrated in the accompanying drawings. In the following description, numerous specific details are set forth in order to provide a thorough understanding of one or more aspects and/or features described or referenced herein. It will be apparent, however, to a person of ordinary skill in the art, that one or more aspects and/or features described or referenced herein may be practiced without some or all of these specific details. In other instances, well-known process steps and/or structures have not been described in detail in order to not obscure some of the aspects and/or features described or referenced herein.

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combination of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used throughout this disclosure, the term “partner” refers to one or more of: an affiliate partner, a co-branded partner, or the like.

FIG. 1A illustrates partner channels for a prior art onboarding system where customers apply for credit products with a partner. When a customer applies for a partner-related credit product, the onboarding system executes a flow comprising one or more functions. Each flow is dedicated specifically to the partner. For example, the onboarding system generates a new partner channel and executes a first flow for the first partner channel 100A or a second flow for a second partner channel 100B. Each flow includes the following functions. The customer submits an application for a partner-related credit product (step 102A or 102B). The credit product application page may be hosted by the partner system.

A process flow engine performs underwriting (step 104A or 104B). A payment gateway creates and submits an application (step 106A or 106B). The onboarding system displays the application status to the customer (step 108A or 108B). Each time a new partner channel is created, a developer needs to create logic that implements functions for creating, processing, and submitting a credit product application related to the given partner. As shown in the figure, the steps in the flows are the same, but the logic (credit product application underwriting, processing, reporting, etc.) may differ as it incorporates partner-specific information such as branding, functions, and configurations. When onboarding a new partner channel, the entire logic has to also be tested. This may lead to inefficient onboarding of new partner channels.

FIG. 1B illustrates a high-level block diagram of an architecture of a prior art partner channel. In some embodiments, the partner channel may be hosted by the partner's system. The architecture 111 comprises a presentation layer 161, a services layer 163, a business layer 165, and a data layer 167. The presentation layer 161 comprises client webapp 117 and admin webapp 119 and is used to present information to one or more users 113 (e.g., customer, admin, developer, etc.). The presentation layer 161 allows a customer applying for a credit product application, or a developer (of the partner or credit product company) developing the new partner channel, to interface with the other layers in the architecture 111.

The services layer 163 comprises application processing logic 123 and reporting logic 125. The application processing logic 123 processes the credit product application, and the reporting logic 125 reports the results. The results reported may include, but are not limited to, the number of approvals, the number of declines, approval status, decline category, decline code, approval data, offer name, offer variant, segment, etc. In some embodiments, at least some of the results may be based on information requested from a partner used to determine pricing and cost. The services layer 163 communicates information (e.g., reporting results) to the external systems 115. The external systems 115 may be systems belonging to one or more partners, and the communication may occur via FTP, email, or the like. In some embodiments, the external systems 115 may communicate partner data to the services layer 163 using an API written by the partner.

In some embodiments, the services layer 163 may comprise partner configuration data (not shown). The partner configuration data may be embedded into the partner channel, and thus, may not be modified.

The business layer 165 comprises a process flow engine interface 127. The process flow engine interface 127 may interface with a process flow engine. The process flow engine may author, test, store, or execute one or more tasks or actions for a given process flow. The process flow may be based on one or more rules or requirements of the partner. In some embodiments, the process flow engine may be external from the partner's system.

The data layer 167 comprises database information such as entities 133, repositories 135, and data transfer objects 137. The entities 133 may represent one or more columns in the database. The repositories 135 may represent the available database queries that are allowed on one or more database tables. The data transfer objects 137 may define the objects that are returned in response to a query (e.g., GET, POST, etc.) The repositories 135 may be communicated to data sources 139, and the data transfer objects 137 may be communicated to services 141. In some embodiments, data that needs to be persisted may be communicated between the data layer 167 and the data sources 139, the services 141, or both. This data may include partner-specific configuration values, product definition, card application submission details, reporting configuration, etc.

When a new partner channel is onboarded into the technology platform, a plurality of layers, including the services layer 163 and business layer 165 would have to be developed and tested. This development and testing of multiple layers in the architecture leads to inefficiencies when onboarding new partner channels.

Exemplary Architecture and Method for a Submitting and Processing a Credit Product Application

Embodiments of the disclosure may include an architecture that performs efficient onboarding of new partner channels, while incorporating unique (e.g., partner-specific) branding and process steps (underwriting, pre- or post-processing, reporting, etc.) for each new partner channel. When a customer applies for a partner-related credit product, the onboarding system may generate a new partner channel using the architecture that has been already developed to perform core functions (functions common to multiple partner channels). The architecture allows a developer to develop logic that performs steps specific to a partner (partner-specific functions). The partner-specific logic may be used along with core logic to execute the steps for creating, submitting, and processing a credit product application.

FIG. 2 illustrates an exemplary onboarding system and flows for different types of partners (e.g., an affiliate partner, co-branded partner, etc.), according to embodiments of the disclosure. The onboarding system may comprise core logic and one or more partner channels. In some embodiments, the development and control of the partner channels (e.g., branding, logic, and configurations) and the development and control of the core logic may be independent from one another. The development and control of the partner channels may not impact the development and control of the core logic, and vice versa. New partner channels implementing different partner-specific functions may be added in a “plug-and-play” manner into the system without risking its infrastructure. This allows for enhanced scalability of the onboarding system (included in the credit product company system).

The core logic may be logic common to the partner channels. In some embodiments, multiple partner channels may be for different types of partners. For example, a first partner channel may be an affiliate partner, and a second partner channel may be a co-branded partner. The first and second partner channels may use the same core logic. In some embodiments, the core logic may be logic that performs mission critical tasks. The core (non-partner specific) logic may comprise a content management system (CMS) 214 and a process flow engine interface 210, which may be external from the credit product company system. The CMS 214 may store partner-specific branding elements.

The core logic may also include a content distribution network (CDN), a web client, web servers, a backend application, an internal facing frontend application, an external (user) facing frontend application, a persistent storage/data layer, or a cache layer (not shown). The backend application may comprise business logic, underwriting logic, content creation, and database orchestration. The internal facing frontend application may be used to service users. The external (user) facing frontend application may collect user information.

The functions of the core logic and the partner-specific logic may be described by way of examples as follows. For a first partner channel 200A, the customer may navigate to a partner-specific application page (step 222). The customer may be directed to the partner-specific application page by clicking on a partner-specific URL. When the customer clicks on the partner-specific URL, the customer may be directed to a web or mobile application page hosted on the credit product company's system.

The system may retrieve partner information, including branding elements and configurations, in step 224. For example, the branding elements may be retrieved from CMS 214. In some embodiments, the partner or credit product company may develop and control its branding and customization via at least the branding elements, and then can cause the system to store the partner-specific branding elements. In some embodiments, the CMS 214 may be located on the credit product company system.

The system may include a process flow engine interface 210, which interfaces with a process flow engine that performs partner-specific functions. The process flow engine may be an external system, in some embodiments. One exemplary function may be to display a user interface for the system's web or mobile application page. The user interface may comprise partner-specific branding elements displayed to a customer. Other exemplary partner-specific functions may include, but are not limited to, pre-processing, application submission, underwriting, or a combination thereof.

FIG. 3A illustrate an exemplary user interface 350 for a partner-specific application page, according to embodiments of the disclosure. The partner-specific application page may include a partner-specific application header 352, customer data 354, partner-specific offer information 356, and the like (e.g., fonts, color schemes, logos, etc.). The partner-specific header 352 may be stored in the CMS. In some embodiments, the branding elements for a given partner may be added to the credit product company system and a partner-specific application page without requiring modifications to the core logic. The user interface 350 may be one that is created by modifying a modular and customizable user interface to include partner-specific information such as partner-specific header 352 and partner-specific offer information 356. In some embodiments, the partner-specific offer information may be included in the one or more partner-specific configurations.

Exemplary partner-specific branding elements 362 are shown in FIG. 3B. The partner-specific branding elements 362 may include a partner-specific header branding element 362A, a partner-specific footer branding element 362B, a partner-specific logo branding element 362C, and a partner-specific icon branding element 362D. The application header 352 may comprise one or more partner-specific branding elements 362. The partner may be able to configure, control, and edit other types of branding elements or layouts, such as the layout of the partner-specific application page, colors, images, logic to show or hide certain fields, etc.

In some embodiments, the CMS may allow a partner to define branding content for the credit product application page without requiring changes to the architecture or logic.

Referring back to FIG. 2, in step 226, the system may perform partner application pre-processing. In some embodiments, the pre-processing step 226 may include making a request to a backend application to retrieve customer data. The customer data may be stored on one or more backend servers, for example. In some embodiments, customer data may be stored on a persistent data server. The backend application may respond with customer data. Additionally or alternatively, the backend application may pre-populate the credit product application with the customer data. The customer data may have been obtained, e.g., by the partner.

The backend server may also perform one or more steps using the core logic. Exemplary steps performed by the core logic may include, but are not limited to, partner data validation, partner authentication, partner authorization, partner security, invoking one or more partner-specific functions, generating terms and conditions, storing card application submission data, invoking underwriting, pre-processing, or post-processing, communicating with one or more systems to create or set up a credit account, communicating information to the customer such as the application status, uploading customer data such as driver's license information, generating a notification of decision to decline document, credit product activation services, credit product management services, etc.

The process flow engine 210 may receive a request (e.g., including partner configuration(s)) and complete the remainder of the partner-specific functions. For example, the process flow engine may decrypt a payload having customer data (sent over by the partner), query the data layer to return the customer data, or call a partner-specific API to retrieve the customer data. One or more partner-specific functions may be added or changed without having to change the core logic. This may occur when a new partner channel is updated or added.

In step 228, the system may receive customer input. The customer input may be provided to the process flow engine. In some embodiments, the system may provide pre-populated customer data. The customer data may be stored, and the system may retrieve it before pre-populating the application. Receiving the customer input may comprise the customer adding information, changing any incorrect information, submitting the application, etc. In some embodiments, the system may not provide pre-populated customer data, and the customer's input may comprise all application information. The process flow engine may perform underwriting in step 230.

The credit product company system may create an application (step 232) using the customer input, stored customer data, or both. The credit product company system may access a payment processing system 212 to submit the application and determine its status. For example, the customer's credit product application may be approved, declined, or pending. One non-limiting example of a payment processing system is Total System Services (TSYS). In some embodiments, the payment processing system 212 may be not be included in the core logic of the credit product company system. The application status may be displayed to the customer in step 234.

For a second partner channel 200B, the customer may navigate to an application page (step 236). The system may retrieve partner information, such as partner-specific branding elements, in step 238 from CMS 214. In step 240, the customer may complete and submit an application. In step 242, the system may perform partner application pre-processing. The respective order of steps 240 and 242 for the second flow of the second partner channel 200B may differ from the respective order of steps 226 and 228 for the first flow of the first partner channel 200A. Different partner channels may process credit product applications differently, as represented by the respective partner-specific functions and logic.

For the second flow for the second partner channel 200B, the process flow engine interface 210 may cause the process flow engine to perform underwriting in step 244 and post-processing in step 246. As shown in the figure, a post-processing step may be included in the second flow, but not in the first flow. The credit application process for the second partner channel may involve a post-processing step, whereas this may not be the case for the first partner channel, for example.

The credit product company system may create and submit an application in step 248, accessing a payment processing system 212. In step 234, the application status may be displayed to the customer.

Embodiments of the disclosure may include different partner channels having different order of partner-specific functions. In some embodiments, the partner information may include information about the one or more partner-specific functions including relative order. The partner information may be provided before the new partner channel is onboarded, the corresponding partner-specific functions may be implemented using this partner information. For example, for the first partner channel 200A, partner application pre-processing (step 226) may be performed before receiving customer input (step 288). Underwriting may be performed (step 230) after receiving the customer input. For the second partner channel 200B, partner application pre-processing (step 242 may be performed after receiving customer input (step 240). Underwriting may be performed (step 244) before post-processing is performed (step 246).

Exemplary Method for Onboarding a New Partner Channel

The onboarding system may onboard a new partner channel using database information. The system may receive partner information (e.g., partner-specific branding elements, partner-specific functions, partner-specific configurations, etc.) of a new partner channel to be onboarded into the credit product company system. The onboarding system may add the partner-specific branding element(s) to the CMS, for example. In some embodiments, the partner-specific branding elements may be uploaded by the credit product company or the partner to the CMS using a CMS user interface. The branding elements may include logos, design elements, trademarks, colors, fonts, layouts, fields, text boxes, etc.

The partner-specific configurations may be stored in the data layer, for example. The partner-specific configurations may be associated with the credit product application and may include product offerings (offer information), product configurations, and the like. Non-limiting exemplary product configurations may include credit offer terms and conditions.

After the system updates the database information with partner-specific configurations, it may generate a partner-specific URL and partner-specific application page. Generating the partner-specific URL and/or partner-specific application page may comprise modifying (e.g., replacing), using a frontend logic, one or more elements with partner-specific branding elements. The partner-specific URL may be provided to the partner. The partner may use a URL link to direct the customer to the partner-specific application page hosted by the credit product company system. The URL may include an ID (partner) and an offer ID.

The architecture allows a developer to develop at least some of the partner-specific logic, which implements partner-specific functions. For example, a first developer may develop the first partner-specific function for the first partner channel 200A, and a second developer may develop the second partner-specific functions for the second partner channel 200B. In some embodiments, the developer may develop the respective partner-specific functions prior to onboarding.

In this manner, new partner channels may be integrated into the system, where the partner-specific functions may be customized specific to each new partner. Integration of a new partner channel may require receiving partner information (logic, branding elements, and configurations). Branding elements may be stored in the CMS 428. Configurations may be stored in the data layer.

The amount of development and testing involved may be reduced with onboarding partner channels due to certain logic being reusable, extensible, flexible, and customizable. Exemplary logic that is reusable, extensible, flexible, and customizable may include, but is not limited to, the credit product application user interface, the credit product terms and conditions document, the credit product underwriting process, reporting, error handling, credit product approval/decline/in review application page to be displayed to the user, credit product approval/decline/in review communication layer, driver's license upload page and logic, etc.

The credit product application user interface may be automatically branded specifically for a partner using the partner-specific branding elements stored in the CMS 428. The credit product terms and conditions document may be generated using the partner configuration 430 stored in the data layer 466.

The reporting configuration may be customized based on the partner configurations. For example, the partner may configure which database information to be included in reports, frequency of sending reports, recipients, and how the reports are to be communicated. The credit product approval/decline/in review application page may be generated using partner-specific branding stored in the CMS 428. The credit product approval/decline/in review communication layer may be used to configure communications from the partner's email to the customer. The driver's license upload page and logic may be generated using the partner information.

In some embodiments, one or more functions, such as the credit product underwriting process and error handling, may be reused without needing changes when adding a new partner channel to the system.

Other exemplary partner-specific functions may include, but are not limited to, asymmetric payload decryption, API integration, database lookups/validation, calling partner specific APIs, etc. Instead of developing, updating, or testing the entire set of logic for each new partner channel (such as shown in FIG. 1), only logic specific to the partner channel needs to be developed, updated, or tested. The partner-specific logic may be programmed to operate with core logic. The core logic may be developed before onboarding the new partner channels. The core logic may be used by multiple partner channels. In some embodiments, one or more core functions (such as displaying a status of an application) may be common to the partner channels and may not be developed, updated, or tested each time a new partner channel is added to the system.

FIG. 4 illustrates a high-level block diagram of an exemplary credit product company system architecture, according to embodiments of the disclosure. The architecture 410 comprises a presentation layer 460, a services layer 462, a business layer 464, and a data layer 466. The presentation layer 460 comprises client webapp 416 and admin webapp 418. The presentation layer 460 may be used to present a user interface to users 412 (e.g., customer, admin, developer, etc.). For example, the user interface may be the credit product application page presented to a customer, or may be the onboarding configuration page presented to a partner. The presentation layer 460 allows a customer applying for a credit product application, or a developer to create a new partner channel to interface with the other layers in the architecture. Embodiments of the disclosure may include all layers being hosted on a single system, such as a credit product company system, or across multiple systems.

The services layer 462 comprises partner data 420, application processing logic 422, and reporting logic 424. The partner data 420 includes data specific to the partner. Non-limiting examples of partner data may be segment data, product data, or the like. The partner data 420 may be data used in application processing steps (underwriting, pre-processing, or post-processing) or reporting steps. Unlike the prior art architecture, the partner data 420 may be stored on the credit product company's system. In this manner, the time needed to onboard the new partner channel may be reduced as the partner data 420 may be retrieved from the credit product company system itself, rather than having to wait for one or more external systems 414 to communicate such data. The application processing logic 422 processes the credit product application, and the reporting logic 424 reports the results. The results reported may include, but are not limited to, number of approvals, number of declines, approval status, decline category, decline code, approval data, offer name, offer variant, segment, etc. In some embodiments, at least some of the results may be based on information requested from a partner used to determine pricing and cost. The services layer 462 communicates information (e.g., reporting results) to one or more external systems 414. The external systems 414 may be systems belonging to one or more partners, and the communication may occur via FTP, email, or the like. In some embodiments, the external systems 414 may communicate partner data to the services layer 462 using an API written by the partner.

The business layer 464 comprises process flow engine interface 426, CMS 428, and partner configuration data 430. The process flow engine interface 426 may interface with a process flow engine. The process flow engine may author, test, store, or execute one or more tasks or actions for a given process flow. The process flow may be based on one or more rules or requirements of the partner. In some embodiments, the process flow engine may be external from the partner's system.

The CMS 428 manages the partner configuration data 430. In some embodiments, the partner configuration data 430 may be metadata that includes, as non-limiting examples, the underwriting flow for the credit product application, reporting configuration, card processing system mapping, etc. In some embodiments, the partner-specific logic may be customized specific to the partner based on the partner configuration 430 for a new partner channel.

When a new partner channel is onboarded into the technology platform, in some embodiments, only the business layer 464 needs to be changed. These changes include, but are not limited to, adding (or updating) one or more branding elements to the CMS 428, adding (or updating) partner configuration 430, or adding partner-specific logic and flows. The branding elements may be used to create an application page, an application process, or an account management process that is branded specific to the partner. The partner-specific logic and flows may reflect a given partner's specific interface for retrieving data, for example. The partner-specific logic and flows may be separate and independent from the core logic. When onboarding a new partner channel, the core logic may not be affected.

The data layer 466 comprises database information. The database information may comprise entities 432, repositories 434, and data transfer objects 436. The entities 432 may represent one or more columns in the database. The repositories 434 may represent the available database queries that are allowed on one or more database tables. The data transfer objects 436 may define the objects that are returned in response to a query (e.g., GET, POST, etc.) The repositories 434 may be communicated to data sources 438, and the data transfer objects 436 may be communicated to services 440. In some embodiments, data that needs to be persisted may be communicated between the data layer 466 and the data sources 438, services 440, or both. This data may include partner-specific configuration values, product definition, card application submission details, reporting configuration, etc.

FIG. 5 illustrates a high-level block diagram of an exemplary process flow for onboarding a new partner channel, according to embodiments of the disclosure. A process flow engine interface 526 may be used to interface with a process flow engine. The process flow engine may perform underwriting, pre-application processing, or post-application processing steps. The partner 512 may be presented with a user interface 502 hosted on the credit product company's system. The user interface 502 may display, e.g., an onboarding configuration page.

The services layer 562 may comprise a backend application and server. The user interface 502 may communicate with the services layer 562 using an API, where the user interface 502 may send customer information (input by the partner) to the services layer 562. The user interface 502 may inform the services layer 562 that a partner has clicked on the partner-specific URL to start the onboarding process. The backend application may perform authentication of the partner, check the partner information, and execute partner-specific flows. In some embodiments, the backend services layer 562 may send data (e.g., onboarding status) from the partner-specific flows to the user interface 502.

The partner's input may cause the services layer 562 to interface with a process flow engine interface 526. The system may allow the partner to create partner-specific flows. In some embodiments, the partner may drag and drop steps into the user interface to create the partner-specific flows (for implementing one or more partner-specific functions).

The process flow engine interface 526 may invoke a partner data fetch service 528 to store or retrieve partner information from a partner prospect database 534. The partner prospect database 534 may include partner data, such as a partner ID, a partner customer ID, an offer ID, an expiration date, attempts, etc. For a given partner, certain information such as customer data may be retrieved for pre-populating the application. The partner data fetch service 528 may retrieve the customer data and send it to the process flow engine interface 526. In some embodiments, the process flow engine interface 526 may send the customer data to the services layer 562, and the services layer 562 may send the customer data to the user interface 502. The user interface 502 may display the credit product application page with at least some of the customer data pre-populated.

The partner data fetch service 528 may interface with an encrypted payload 530, a partner API 532, and a partner prospect database 534. In some embodiments, a partner may send customer data encrypted inside the partner-specific URL. The encrypted payload 530 may decrypt the customer data from an encrypted payload.

The partner API 532 may be a partner generated API. In some embodiments, the partner API 532 may retrieve customer data, when called by the credit product company's system. The customer data may be sent to the process flow engine interface 526 and process flow engine after being retrieved.

FIG. 6 illustrates a flow chart of an exemplary process for onboarding a new partner channel, according to embodiments of the disclosure. As discussed above, onboarding a new partner channel may be efficient and simple, where new partner channels may be onboarded into the technology in a “plug and play” manner. Process 600 may include receiving a new partner in step 601 and associated partner information. Step 602 may comprise using the process flow engine to create a new partner-specific logic and flows. In step 604, the new partner channel may be added in the admin user interface (UI). The admin UI may be displayed on the admin webapp, for example. In some embodiments, the admin UI may display the onboarding configuration page.

The partner information (including partner configuration) may be input and stored in the data layer. In some embodiments, the data layer may be stored by the credit product company's system. The admin UI may be used to add and set up the partner using user-friendly and easily accessible tools.

After step 604, reporting variables may be configured in step 612 using an onboard configuration page. A partner may have partner-specific requirements and needs. The admin UI may provide the partner with a user-friendly, streamlined way to specify certain configurations, such as reporting configurations. For example, the partner may specify which tables and columns to include in reports, frequency of reporting, type of communication for reporting, recipients, etc. using the admin UI.

The branding and customization information may be included in the partner information, which may be input using an internal facing front-end application (web client, as one non-limiting example). The branding and customization information may be represented by partner-specific branding elements. In some embodiments, the partner information may be stored in and retrieved from a persistent storage layer.

FIG. 7 illustrates an exemplary onboard configuration page for onboarding a new partner channel, according to embodiments of the disclosure. The onboarding configuration page 700 may be an internal facing page, for example, that may be completed by the partner or credit product company. The developer may input, as non-limiting examples, the channel name 702, FTP information 704, and reporting information 706. After inputting the partner information, the developer may click on the graphical UI (GUI) button 710 to onboard the new partner channel into the technology platform. In some embodiments, the developer may only have to complete the information required by the onboarding configuration page in order to onboard the new partner channel.

Returning back to FIG. 6, step 606 may comprise adding an offer in the admin UI, followed by adding an associated offer fee in the admin UI in step 614. If the partner is displaying a new product offering to customers, it can use the admin UI to add the product offer details to the data layer. The correct terms and conditions document for the product offering may be generated using the product offer details, and then displayed to the customer. The offer fee may be stored in the data layer. In some embodiments, the partner may set up a fee structure and associate it with the new product offering using the admin UI.

In step 608, the system may add partner-specific branding elements to the CMS. The partner-specific branding elements may be retrieved for, e.g., a credit product application page. The frontend logic may query the CMS for the partner-specific branding elements, and replace generic elements with the partner-specific branding elements. The querying and replacement may occur without changing the frontend logic.

The system may also develop an app data API service (step 610). The app data API service may retrieve customer data. In some embodiments, the app data API service may be invoked by the process flow engine. If, for example, the partner wants to add an offer, a developer (of the partner or credit product company) would use the admin UI to provide offer information to define the offer. The system may store the offer information in the data layer.

In some embodiments, the partner or credit product company may add a fee by using the admin UI to define the fee structure. After the fee structure is defined, the partner or credit product company may associate the fee structure with the corresponding offer. The system may generate the terms and conditions document, retrieving the fee structure and offer information from the data layer.

In some embodiments, partner-specific branding elements may be created or edited using the admin UI. The partner or credit product company may fill out the necessary fields in the admin UI, where the fields may modify text, logos, color schemes, etc.

FIG. 8 illustrates an exemplary flow implemented by a process flow engine, according to embodiments of the disclosure. As shown in the figure, a single process flow may be invoked (by the core logic) at 802 and 804. Then, at 806 and 808, different partner-specific flows may be implemented for different partners.

Exemplary Reporting Engine

Embodiments of the disclosure may include a reporting engine that allows a partner self-service access to metrics and data. The reporting engine may modify modular and customizable reporting files to include partner-specific information. In this manner, the entirety of the reporting files do not have to be generated each time the partner accesses the metrics and data. The partner may use the reporting engine to receive daily and monthly reporting, date range reporting, a list of email recipients, file transfer configurations, etc.

FIG. 9 illustrates an exemplary reporting flow of a new partner channel integrated into the technology platform, according to embodiments of the disclosure. Process 900 may begin with loading a reporting configuration in step 904 for every partner with the reporting feature enabled. If the reporting involves daily reporting, then in step 906, the system may query a database for all submissions (e.g., credit product application submissions) in the last certain number of days. In some embodiments, the number of days to be included in the query and reporting may be configured by each partner. For example, the system may query the database for all submissions in the last 5 days, 10 days, 20 days, etc. If the reporting involves monthly reporting, then in step 908, the system may query a database for all submissions in the last month.

In step 910, the system may determine whether there are partner-specific branding elements to be used for the reporting. The partner-specific branding elements may be stored in a CMS file, for example. If there are partner-specific branding elements, the system may generate the report using the partner-specific branding elements and the query results, in step 914. For example, the report may be in the form of a comma-separated values (CSV) file comprising a partner-specific header. The columns of the CSV file may comprise the query results. Otherwise, if there are no partner-specific branding elements, the system may generate the report using default elements (e.g., a default header) and the query results.

In step 916, the system may send an email with the reporting file to recipients. A list of the recipients may be stored in the reporting configuration, for example. The reporting configuration may be stored in the data layer hosted by the credit product company's system, for example. In step 918, the system may send the reporting file to an FTP location. The FTP location information may be stored in the reporting configuration. The partner may use the FTP location to receive the report. In some embodiments, the partner ay define the FTP location.

The reporting engine may dynamically build the reporting configuration using the partner name in step 922 and repeat the reporting process based on the frequency of reporting. The reporting engine may query for a partner-specific reporting configuration, which may be stored in the data layer. The partner-specific configuration is added, and the reporting engine may automatically generate the reports. The reporting process may complete at step 920.

FIG. 10 illustrates a block diagram of an exemplary system 1002, according to embodiments of the disclosure. The system may be a machine such as a computer, within which a set of instructions, causes the machine to perform any one of the steps and processes discussed herein, according to embodiments of the disclosure. In some embodiments, the machine can operate as a standalone device or may be connected (e.g., networked) to other machines. In a networked configuration, the machine may operate in the capacity of a server or a client machine in a server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, a switch or bridge, or any machine capable of executing a set of instructions (sequential or otherwise) that specify actions to be taken by that machine. A mobile device such as a PDA or a cellular phone may also include an antenna, a chip for sending and receiving radio frequency transmissions and communicating over cellular phone WAP and SMS networks, and a built-in keyboard. Further, while only a single machine is illustrated, the term “machine” shall also be taken to include any collection of machines that individually or jointly execute a set (or multiple sets) of instructions to perform any one of the methodologies discussed herein.

The exemplary computer 1002 includes a processor 1004 (e.g., a central processing unit (CPU), a graphics processing unit (GPU), or both), a main memory 1006 (e.g., read-only memory (ROM), flash memory, dynamic random access memory (DRAM) such as synchronous DRAM (SDRAM) or Rambus DRAM (RDRAM), etc.), and a static memory 1008 (e.g., flash memory, static random access memory (SRAM), etc.), which can communicate with each other via a bus 1010.

The computer 1002 may further include a video display 1012 (e.g., a liquid crystal display (LCD) or a cathode ray tube (CRT)). The computer 1002 also includes an alpha-numeric input device 1014 (e.g., a keyboard), a cursor control device 1016 (e.g., a mouse), a disk drive unit 1018, a signal generation device 1026 (e.g., a speaker), and a network interface device 1022.

The drive unit 1018 includes a machine-readable medium 1020 on which is stored one or more sets of instructions 1024 (e.g., software) embodying any one or more of the methodologies or functions described herein. The software may also reside, completely or at least partially, within the main memory 1006 and/or within the processor 1004 during execution thereof by the computer 1002, the main memory 1006 and the processor 1004 also constituting machine-readable media. The software may further be transmitted or received over a network 1004 via the network interface device 1022.

While the machine-readable medium 1020 is shown in an exemplary embodiment to be a single medium, the term “non-transitory computer-readable medium” should be taken to include a single medium or multiple media (e.g., a centralized or distributed database and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A computer-implemented method for processing a credit product application, the method comprising:
directing a customer to an application page hosted by a credit product company system;
retrieving one or more partner-specific branding elements from a content management system;
performing one or more partner-specific functions using partner-specific logic, the one or more partner-specific functions comprising at least one of:
invoking, using a process flow engine interface, a process flow engine to perform underwriting, partner application pre-processing, or partner application post-processing,
displaying a user interface, wherein the user interface comprises the one or more partner-specific branding elements,
receiving customer input,
creating the credit product application using the customer input, or
submitting the credit product application; and
displaying a status of the credit product application,
wherein the content management system and the process flow engine interface are included in core logic of the credit product company system.

2. The computer-implemented method of claim 1, wherein the core logic comprises one or more of: a content distribution network, a web client, web servers, a backend application, an internal facing front end application, an external facing front end application, a data layer, or a cache layer.

3. The computer-implemented method of claim 1, wherein the performing the one or more partner-specific functions comprises requesting a backend application to retrieve customer data.

4. The computer-implemented method of claim 3, the method further comprising:
pre-populating the credit product application with the customer data.

5. The computer-implemented method of claim 3, the method further comprising:
decrypting the customer data from an encrypted payload.

6. The computer-implemented method of claim 1, the method further comprising:
retrieving one or more partner-specific configurations from a data layer of the credit product company system, wherein the user interface further comprises one or more partner-specific offer information, the one or more partner-specific offer information included in the one or more partner-specific configurations.

7. The computer-implemented method of claim 1, wherein the one or more partner-specific functions are defined by a partner when onboarding a corresponding new partner channel into the credit product company system.

8. A computer-implemented method for onboarding a new partner channel into a credit product company system, the method comprising:
presenting a user interface of an onboarding configuration page;
receiving partner information of the new partner channel, wherein the partner information comprises one or more partner-specific branding elements, one or more partner-specific functions, or one or more partner-specific configurations;
sending the partner information to a services layer;
adding the new partner channel to an admin user interface;
creating a partner-specific application page; and
developing partner-specific logic for implementing the one or more partner-specific functions, wherein the partner-specific logic is programmed to operate with core logic, wherein the core logic is developed before the onboarding the new partner channel and is used by multiple partner channels.

9. The computer-implemented method of claim 8, wherein the creating the partner-specific application page comprises creating a partner-specific user interface for a partner-specific application page.

10. The computer-implemented method of claim 9, wherein the creating the partner-specific user interface for the partner-specific application page comprises modifying a user interface by including the one or more partner-specific branding elements.

11. The computer-implemented method of claim 8, wherein the developing the partner-specific logic comprises modifying logic to include the one or more partner-specific branding elements, the one or more partner-specific functions, or the one or more partner-specific configurations.

12. The computer-implemented method of claim 8, the method further comprising:
generating reporting configurations for the new partner channel using the one or more partner-specific configurations.

13. The computer-implemented method of claim 12, wherein the reporting configurations specify one or more of: which tables and columns to include in reports, frequency of reporting, or recipients.

14. The computer-implemented method of claim 8, wherein after the developing the partner-specific logic, testing only the partner-specific logic.

15. The computer-implemented method of claim 8, wherein the onboarding configuration page allows a partner to drag and drop steps to create partner-specific flows for implementing the one or more partner-specific functions.

16. A credit product company system architecture comprising:
a presentation layer programmed to present a user interface to a user;
a services layer comprising partner data used in application processing steps or reporting steps;
a business layer comprising a process flow engine interface, a content management system, and partner configuration data, wherein the process flow engine interfaces with a process flow engine; and
a data layer comprising database information, the database information comprising entities, repositories, and data transfer objects.

17. The credit product company system architecture of claim 16, wherein the services layer communicates reporting results to one or more external systems.

18. The credit product company system architecture of claim 16, wherein when onboarding a new partner channel into the credit product company system, only the business layer is changed.

19. The credit product company system architecture of claim 18, wherein the changing only the business layer comprises: adding one or more partner-specific branding elements to the content management system, adding the partner configuration data, or adding one or more partner-specific logic and flows.

20. The credit product company system architecture of claim 16, wherein the user is a new partner, the architecture further comprising:
a backend application that sends partner information received by the user interface to the services layer, authenticates the new partner, checks the partner information, and executes partner-specific flows.
